(19) United States
(12) Patent Application Publication
(10) Pub. No.: US 2010/0312677 A1
(43) Pub. Date: Dec. 9, 2010

(54) COMMUNICATION NETWORK RATING AND CHARGING ENGINE

(76) Inventor: Thomas Godfrey Gardner, Bristol (GB)

Correspondence Address: JACOBSON HOLMAN PLLC, 400 SEVENTH STREET N.W., SUITE 600, WASHINGTON, DC, 20004, US

(21) Appl. No.: 12/733,969

(22) PCT Filed: Oct. 6, 2008
(86) PCT No.: PCT/IE2008/000096

§ 371 Date: Aug. 12, 2010

Related U.S. Application Data
(60) Provisional application No. 60/960,608, filed on Oct. 5, 2007.

(51) Int. Cl. G06Q 30/00; G06F 17/30; G06Q 10/00

(52) U.S. Cl. 705/30; 707/802; 707/E17.044

(57) ABSTRACT

A rating and charging engine (1) comprises an engine core (2), having an accounts/pots/resources/rules persistent database (3), and a provisioning system (4). The core (2) interfaces with a service supply entity (10) such as an IN (intelligent network) service control point, and with an external rating and charging entity (20). The engine (1) overcomes the ‘combinatorial explosion’ limitation of the prior rating and charging approaches by reducing complexity. Most of the rating and charging rules are associated with pot types, and each pot has its own set of rules. The core (2) executes pot traversal rules according to at least one parameter to efficiently determine which pots cannot fulfil a service event, thus immediately narrowing down the rule base to execute. This is very important for real-time performance, where there may be in excess of tens of thousands of service events per second arriving at the core (2). This ensures many hitherto difficult requirements can be simply and rapidly implemented and provisioned, including arbitrary combinations of: cross-service bundles, single-purpose bundles, and time and volume limited bundles.

### FIELD OF THE INVENTION

The invention relates to communication networks providing subscriber services, and specifically to a rating and charging engine for such networks.

### PRIOR ART DISCUSSION

A rating and charging engine determines how much a service (e.g. a phone call) costs, and deducts that cost from a subscriber's account. A high-performance real-time engine implements those operations before the service is delivered to the subscriber. If there are insufficient resources in the account then the service delivery does not occur, thus preventing revenue loss.

FIG. A shows the typical prior art architecture. Such a rating and charging engine repetitively executes steps such as the following:
Upon receipt of a service event, the engine retrieves the associated account and its resources from the persistent database. The number and type of the resources is traditionally limited and inflexible.
The engine iterates sequentially through the rating and charging rules to determine whether there are sufficient resources to satisfy the request, changing the resources as appropriate.
The engine stores any changed resources into the persistent database, and sends a response to the service supply entity, specifying the result of the service event's execution.

From consideration of the examples given below, it will be apparent to someone skilled in the art that the problems arising from this structure are:
The rating and charging engine contains all the rating and charging rules for all the service types (and combinations of service types) for all the network operators. The system's complexity is proportional to the product of service types, network operators, and resources, and hence there is a “combinatorial explosion” during product development and maintenance. Over time, the ability to customise the product for each network operator becomes limited to changing pre-defined parameters specified early in the product's development; it becomes increasingly impractical to extend the product to implement an individual network operator's non-standard requirements within an acceptable time. In effect, the product becomes brittle, inflexible, and unmaintainable.
The complexity of the rating and charging rules imply that in order to determine whether or not a resource can be used to satisfy a request, it is often necessary to perform the full rules and calculations. That reduces performance and encourages inflexible and poor system design.
Where resources are valid for limited periods or are “topped up” at intervals, provisioning operations must add or change resources at specific instants in time. In the case that a system is heavily loaded and/or many accounts' resources are involved, such provisioning operations can cause the engine's real-time behaviour guarantees to be violated. This reduces operator's freedom by requiring such operations to occur at inconvenient times, and in a specific order.

Even very simple requirements can lead to either unacceptable real-time performance due to large-scale provisioning operations, or alternatively to surprisingly complex rules.

For example, presume there are one million subscribers, and a subscriber is allowed to download three free ringtones on Saturday. Every subscriber's account contains a “free ringtone” resource that is stored in a persistent database. Changing its value imposes a system load equivalent to one service event, and takes 1 ms; provisioning operations have the same priority as service events. This can be achieved by either:
(a) developing complex rules to logically make decisions according to conditions and current parameters such as current time, and example being: “if this service event is for ringtones and it is Saturday and the resource's value has not already been changed, then change the resource's value to three”; or
(b) by having large-scale high-speed provisioning operations which reduce real-time performance but operate with simple rules such as: “As close as possible to 00:00 on Saturday, individually change each of the million accounts' free ringtone resource to three” and “As close as possible to 00:00 midnight on Sunday individually change each of the million account's free ringtone resources to zero”.

A major problem with approach (a) is that the rules are complex and so there is an unacceptably excessive elapsed time between the requirements specification and provisioning of the rules. A major problem with approach (b) is that there is an unacceptable delay with provisioning of the accounts because it is not possible to re-provision simultaneously all of the accounts at the desired point in time.

Another example is a simplified version of one network operator's unusual specific requirements, which illustrates how a combinatorial explosion can begin. Presume that network operator X is currently using standard rating and charging rules. Network operator Y requires the same rules but also has their own rules for valued subscribers:
usually services' cost and associated rating rules are unchanged;
for each subscriber, during a specified period, the system records the number and duration of phone calls made to a destination defined by the subscriber;
if that number and duration exceeds a threshold, then during the next period there is a predefined random probability that a phone call to the selected number is free;
similar but different reductions apply for other service types.

Adding network operator Y:
requires extra resources for each subscriber (for example, the destination number);
requires extra rules in the rating and charging engine for each service type;
reduces system performance because extra rules and resources are evaluated for each service event. Such performance reduction may be tolerated by network operator Y, but would not be acceptable to network operator X for whom there is no benefit.

That reasoning can be repeated each time a new network operator's requirements are defined, demonstrating that the rules' complexity is proportional to the number of network operators.

In another example, we illustrate how adding new service types can begin a combinatorial explosion. Consider adding a new type of service type, such as the ability to pay for ringtones. In general this will require:
for each different network operator, new rules defining a ringtone's cost;
one or more new resources such as a resource defining the remaining number of free ringtones that a network operator can download.

That can be repeated each time a new service type is defined, demonstrating that the system complexity is proportional to the number of service types.

From the above examples it can be inferred that adding a new resource in general requires new rules for each network operator and each service type. Hence, complexity is also proportional to the number of resources. Thus, the overall system complexity is proportional to the product of service types, resources, and network operators.

The invention is therefore directed towards providing an improved rating and charging engine.

### SUMMARY OF THE INVENTION

According to the invention, there is provided a communication network rating and charging engine comprising:
a network interface adapted to receive service events and to send service responses,
a persistent database storing:
   a plurality of subscriber accounts, each account containing one or more pots, each pot containing one or more resources consumed during performance of a service by the network, and
   rating and charging rules associated with the pots;
an engine core adapted to generate service responses by:
   performing in real time a pot traversal operation to determine pots to utilise for a received service event, the pot traversal operation using a value of at least one parameter, and
   performing real time rating and charging by executing the rating and charging rules associated with those pots; and
a provisioning system adapted to provision said rules, accounts, pots, and resources in the persistent database.

In one embodiment, each pot is an instance of a pot type. Preferably, each pot type is associated with a set of rating and charging rules. Also, each pot is preferably associated with a set of one or more resources defined by the pot's associated pot type.

In one embodiment, each resource is an instance of a resource type.

In one embodiment, the engine core is adapted to recognise service types, and each pot type contains separate rating and charging rules for each <service type, resource type> pair. In one embodiment, the engine core is adapted to generate a pot list in a priority order when performing a pot traversal operation, and for attempting to use the pots in the priority order.

In one embodiment, the engine core is adapted to receive a parameter value in real time. Preferably, the engine core is adapted to extract a parameter value from a service event.

In one embodiment, the engine core is adapted to retrieve a parameter value from a pot. A parameter value may be an attribute of a resource such as quantity. In one embodiment, the engine core is adapted to extract from a service event a value of a service type parameter. In one embodiment, the engine core is adapted to extract from a service event a value of a parameter representing service quantity. In another embodiment, the engine core is adapted to extract from a service event a value of a parameter representing service event time.

In one embodiment, the engine core is adapted to extract from a service event a value of a parameter representing source or destination address.

In one embodiment, the engine core is adapted to initially use a parameter value to exclude pots that it can determine cannot fulfil the service event, and to pass the service event or a parameter to non-excluded pots, and the pots are adapted to determine autonomously whether they can fulfil the service event and to inform the engine core accordingly.

In one embodiment, at least some pots include at least one parameter value indicating its suitability for particular, service types, and the engine core is adapted to use said parameter values during pot traversal.

In one embodiment, at least some pots include at least one parameter value for use by the engine core in determining a pot priority order.

In one embodiment, the rating and charging rules associated with at least two pot types are of different processing techniques. In one embodiment, the processing techniques include one or a combination of decision trees, look-up tables, polynomial equations, blackboard systems, forward chaining production systems, and backward chaining inference engines.

In one embodiment, at least some pots are remote routing pots adapted to automatically and autonomously forward a service event to an external rating and charging entity. Preferably, said pots include rating and charging rules that are sufficient to decide whether or not to forward a service event to an external rating and charging entity.

In one embodiment, the engine core is adapted to delay retrieval of pots with their resources and associated rules from the database until they are required.

In one embodiment, the engine core is adapted to, when a service event for an account is received, retrieve from the database to memory all of the account's pots with their resources and associated rules, if this account's pots are not already in memory.

In one embodiment, the provisioning system is adapted to provision accounts, pots, resources, or rules in real time when they are first required in performance of network services or at any convenient time in advance of it being possible for them to be used in performance of network services.

In another embodiment, the provisioning system is adapted to send a notification to the engine core when a change to the persistent database has been made.

In one embodiment, the provisioning system is adapted to delete pots in real time when it is first apparent that they can no longer be used in performance of network services or at any convenient time after they can no longer be used in performance of network services.

In one embodiment, the engine core is adapted to retrieve all of the rules to memory at initialization or whenever the rules are re-provisioned.

In another aspect, the invention provides a computer readable medium comprising software code for performing operations of an engine defined above when executing on a digital processor.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 shows at a high level a rating and charging engine of the invention, and its context;

FIG. 2 illustrates the functional entities of the engine;

FIGS. 3 to 8 are flow diagrams illustrating operation of the system in more detail; and

FIG. 9 is a sequence diagram illustrating operation of the engine for a particular scenario.

### DESCRIPTION OF THE EMBODIMENTS

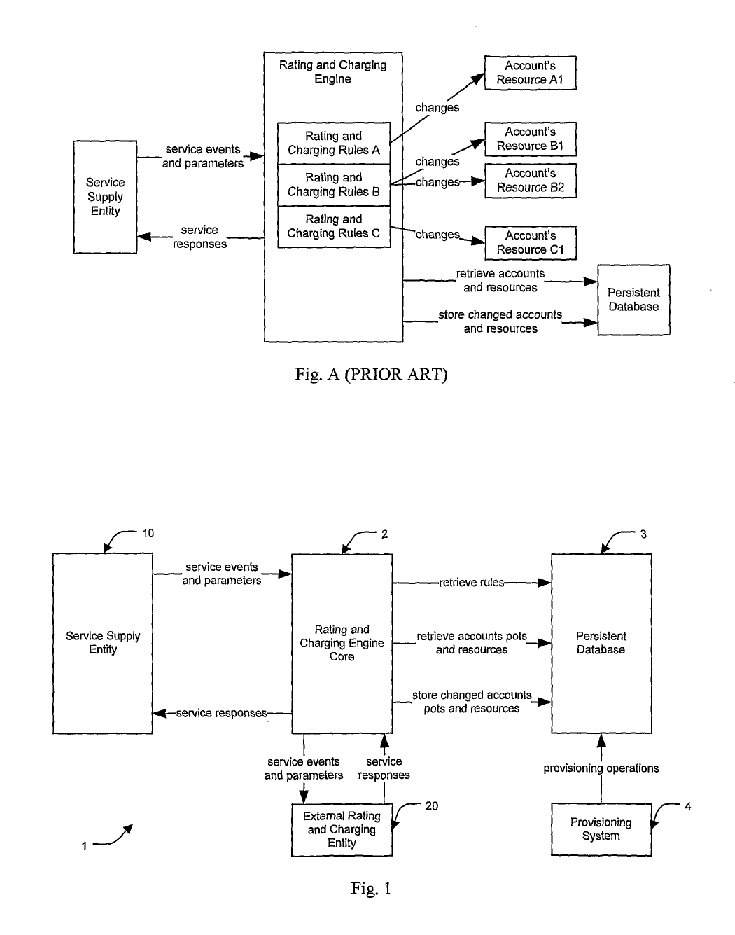

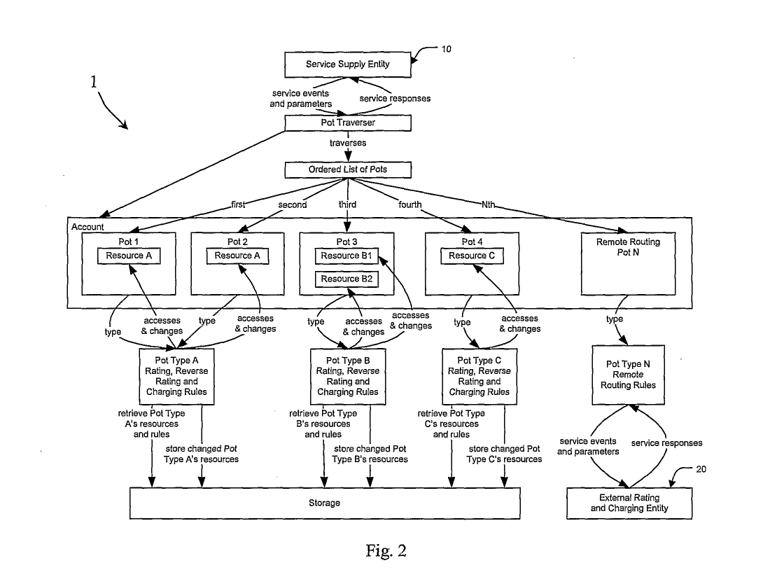

Referring to FIGS. 1 and 2 a rating and charging engine 1 comprises an engine core 2, comprising in hardware terms a cluster of one or more servers and in software terms programs for executing rating and charging rules. The engine 1 also comprises an accounts/pots/resources/rules persistent database 3, and a provisioning system 4. The core 2 interfaces with service supply entities 10 (only one of which is shown) such as an IN (intelligent network) service control point, and with external rating and charging entities 20 (again, only one of which is shown).

The provisioning system 4 creates, changes, and deletes accounts, pots, resources, and rules stored in the persistent database 3. The service supply entities 10 originate service events requesting authorisation to deliver services as specified by parameters in the service event. Henceforth, the term “service event” is used to mean any event or request which is received from the service supply entity 10. The rating and charging engine 1 processes the service events by performing rating and charging calculations, changing the state of the accounts, pots, and resources, and sending a service response specifying whether the delivery is authorised or denied.

A network interface of the core 2 interfaces to external service supply entities. In one example it uses the DIAMETER protocol to receive service events, and it unpacks and forwards the information contained in them to processing functions of the core 2. Some of the information in the service events are parameters used by the core 2 for real time rating and charging as described below. The core generates responses which are packaged by the network interface and it uses in this example the DIAMETER protocol to send the responses to the service supply entities. The persistent database 3 stores subscriber accounts, each account containing one or more pots, each pot containing one or more resources consumed during performance of a service by the network, and also stores rating and charging rules associated with the pots. The provisioning system 4 provisions the accounts, pots, resources, and rules in the persistent database 3. The engine core 2 generates the service responses by:
performing in real time a pot traversal operation to determine pots to utilise for a received service event, the pot traversal operation using a value of at least one parameter, and
performing real time rating and charging by executing the rating and charging rules associated with those pots.

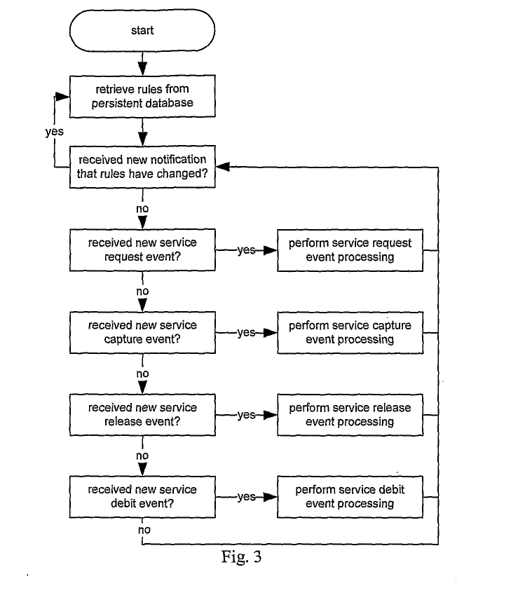

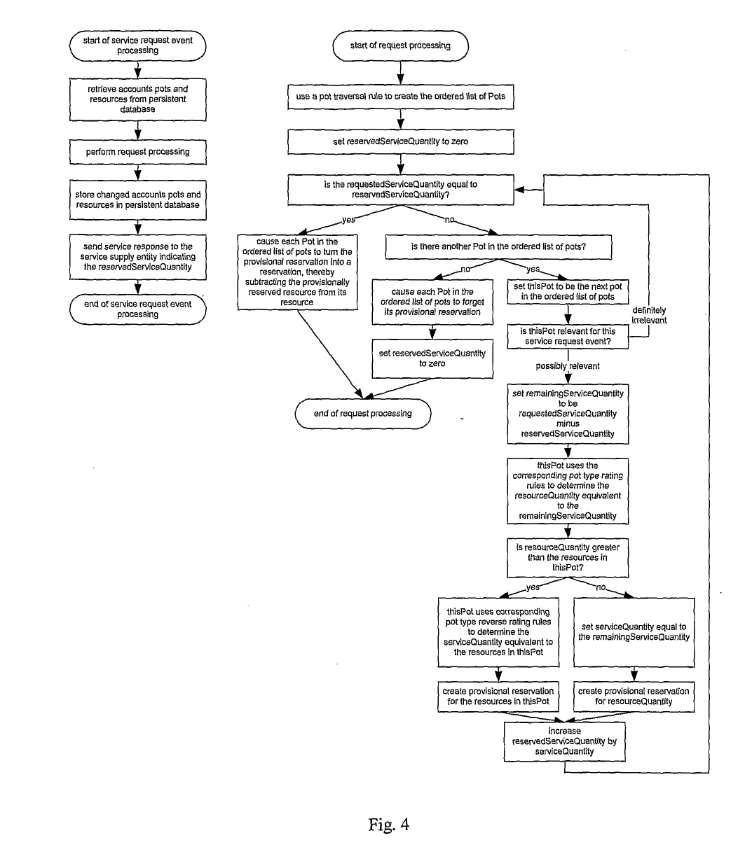

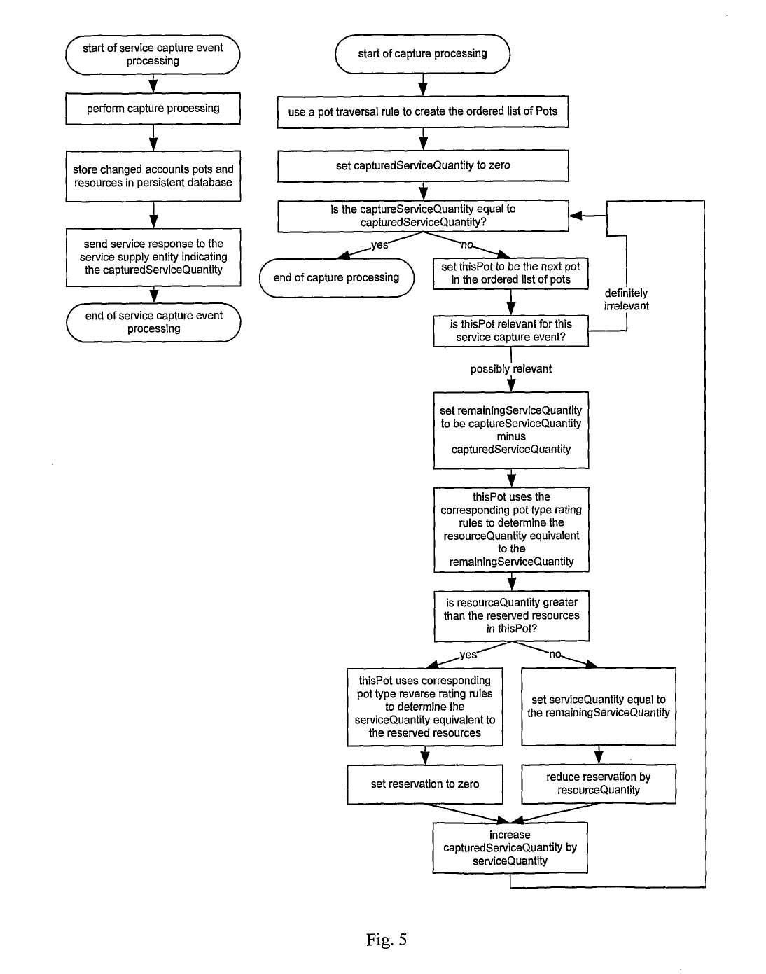

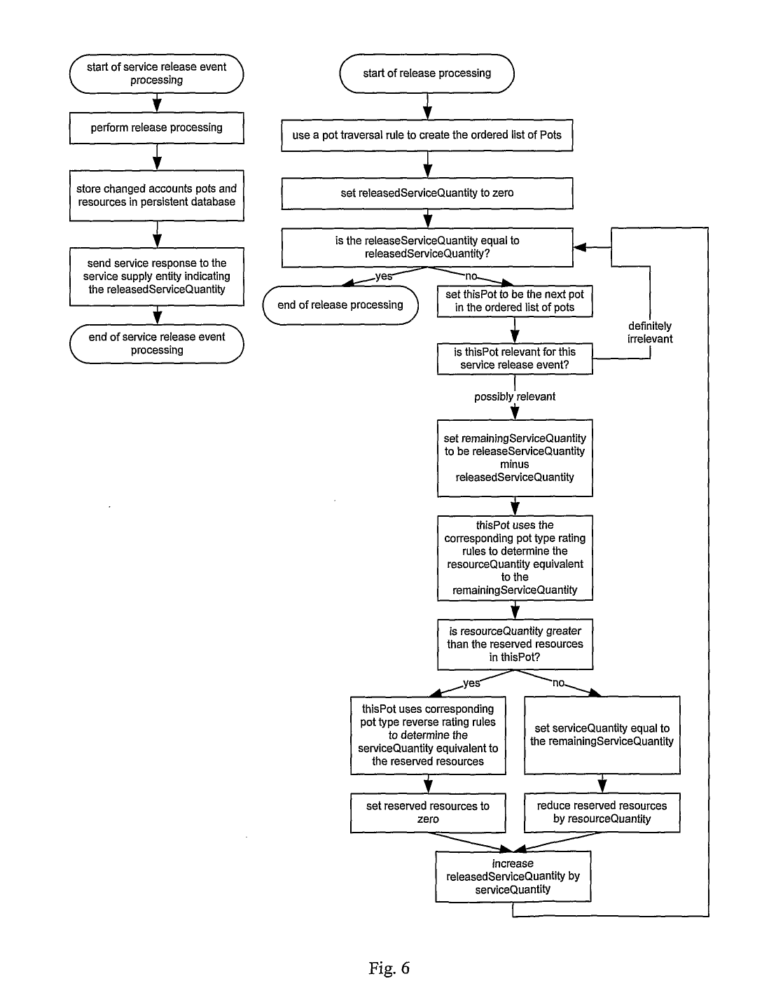

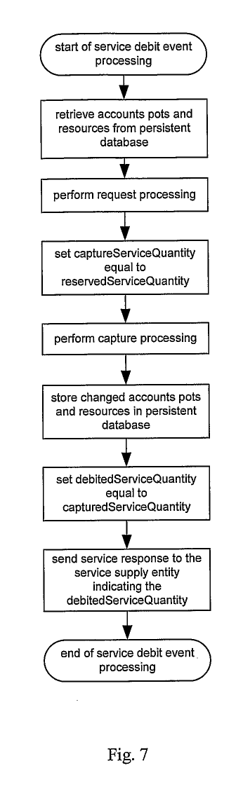

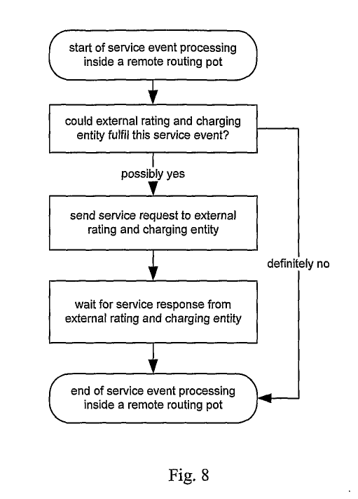

Operation of the engine 1 is illustrated in flow diagram form in FIGS. 3 to 8, in which FIG. 3 illustrates the processing at the top-level, FIG. 4 illustrates processing of a service request, FIG. 5 illustrates processing of a service capture, FIG. 6 illustrates processing of a service release, and FIG. 7 illustrates processing of a service debit, and FIG. 8 illustrates the internal processing within a remote-routing pot. These diagrams illustrate the advantageous aspect whereby pot traversal is performed by the core 2 and there is a much reduced set of rules to process, as explained in more detail below.

Examples of service supply entities, resources, events and parameters are given below.

In this specification the term “service types”, has its normal meaning in this art, examples including voice call, SMS delivery, parking ticket processing, ringtone download, and road toll processing.

There are one or more “service supply entities”. Examples of service supply entities in a telecommunications network include IN Service Control Points, SMSCs, MMSCs, and application servers. Other service supply entities could include road toll systems, parking ticket dispensers, or anything that can benefit from pre-delivery verification that sufficient funds are available.

The service supply entities generate both session-based and isolated “service events” and receive the corresponding service responses.

Examples of session-based service events are:
“Service request”, asking permission to deliver a quantity of a service type; the corresponding cost is temporarily made unavailable for other service requests by creating a “reservation”. A service request may optionally specify both a desired quantity and a minimum quantity.
“Service capture”, stating that some or all of a previously requested service has been delivered and that the reservations should be permanently deducted from the account.
“Service release”, stating that some or all of the previously requested service has not and will not be delivered, and hence any reservation should be returned to the account for use by other service requests.
Any combination of the above.

For example, a long voice call might therefore consist of an initial service request followed by more service requests to extend the call, followed by a service capture and a service release that completes the call.

The isolated non-session-based service events include “service debit”, requesting permission to deliver a quantity of a service type with no possibility of subsequently releasing part of the requested quantity. This is a higher-performance variant of a service request followed by a service capture.

There are one or more “accounts” per subscriber such as an individual child's account and a shared family account. Also there can be one or more subscribers per account such as a corporate account or a shared family account.

“Resources” are consumed in response to service events. Each resource has a specific type, such as financial currency, time, volume, number of messages, external currency (for promotions), ammunition (for a game), or a simple integer counter. The term “resource” includes resources which do not have an upper limit in the extent to which they are consumed, for example unlimited free SMS messages for a subscriber during a weekend, in which the resource is not consumed and may indeed have a zero value.

Also, the term “pot type” is used in this specification, meaning an object-oriented class which is instantiated to provide “pots”. A pot type defines for instances of its pot:
rating and charging rules
the number and type of resources.

There are one or more “pots” per account, each pot being of a single pot type

Accounts, pots, resources and rules are stored in the persistent database 3. A pot's “charging rule” defines when and how resources are loaded from and stored into the persistent database 3. The rules are loaded into the rating and charging engine core 2 from the database 3 when the rating and charging engine 1 is initialised. Also, whenever a rule, an account, a pot, or a resource is changed by the provisioning system 4 a notification is sent to the core 2, triggering a re-load of some or all of these items. FIG. 3 illustrates a notification being received when a rule is changed, in one example.

Given a request for a quantity of a service type, a “rating rule” calculates the corresponding cost in terms of quantity of one or more resources. For each rating rule there is a corresponding “reverse-rating rule” which calculates the maximum quantity of a service that could be purchased for a given quantity of a resource.

“Remote routing pots” are specialised and simplified pots that only contain rating and charging rules sufficient to enable the system to delegate service events to external rating and charging entities.

The rating and charging engine 1 of the invention differs primarily from the prior art by having an advantageous architecture for management of the rules and resources. It significantly simplifies both the rules and the rule execution by:
maximising cohesion between rules and associated pots and resources, and
minimising the coupling between logically unrelated rules and pots and resources.

The rating and charging engine 1 overcomes the “combinatorial explosion” limitation by reducing the complexity to the sum of service types plus network operators plus pots (including their associated resources). It simplifies provisioning operations by relaxing constraints on what is allowable. Most of the rating and charging rules are stored in the persistent database 3 with associations to the pot types, and hence each pot has it own set of rules. The core 2 merely executes pot traversal rules to efficiently determine which pots cannot fulfil a service event, thus immediately narrowing down the rule base to execute. This is very important for real-time performance, where there may be in excess of tens of thousands of service events per second arriving at the core 2.

This ensures many hitherto difficult requirements can be simply and rapidly implemented and provisioned, including arbitrary combinations of: cross-service bundles, single-purpose bundles, time and volume limited bundles, time and volume dependent costing (including loyalty scheme bonuses), external rating and/or charging (sometimes called a rating/charging router), individual network operator's unusual custom requirements. In addition, it enables implementation and provisioning of such features that are only defined after the first version of the product has been deployed.

Referring to FIG. 2, the rating and charging rules for a pot are directly associated with the pot's type and only with that pot's type, as opposed to the prior art approach of having centralised rules.

The remaining rules in the engine core 2 are common to all pot types. Service events (e.g. request, capture, release, debit etc) cause the ordered traversal of all pots in the account by a pot traverser until the event is either completely satisfied or cannot be satisfied. As part of that process, reservations are created, accounts are debited or reservations are deleted as appropriate.

An account may contain pots that cannot use their resources to fulfil a service event. As described below, individual pots calculate whether or not they can fulfil individual service events, but the complexity of that calculation can result in unacceptable loss of real time performance. The pot traverser initially quickly excludes pots that it can determine cannot fulfil the service event, based at least on:
the service type plus the resource type of the resources contained in the pot, and
the instant (including time of day, date, day of week, day of month, year) at which the service event occurred plus whether the pot is “valid” at that instant.

For the non-excluded pots only, the pot traverser passes the service event to those pots and they determine whether they can fulfil the service event. This avoids unnecessary real-time performance loss arising from unnecessary calculations.

The invention makes it very easy to provision new pot types embodying complex network operator-specific requirements.

An account can contain one or more pot instances, each with an arbitrary pot type. Each pot type is an object oriented class containing methods specifying the rating and charging rules for that pot type. Each pot type contains separate rules for each <service type, resource type> pair. This ensures:
each pot's rules will typically be much simpler, and hence easier to create, test and maintain, and
conflicts between rules can be resolved by splitting the rules across multiple pots and pot types

There is no restriction on the techniques used to define and implement the rating and charging rules, nor is there any requirement that all pot types use the same technique. Thus, different pot types might use:
a decision tree,
a lookup table,
a polynomial equation,
a blackboard system,
a forward-chaining production system,
a backward-chaining inference engine, or
any combination of those techniques

A backward chaining inference engine starts with goals and hypotheses, and uses inference rules to determine if there are sufficient facts and data available to completely support the goals and hypotheses.

A forward chaining production system starts with the available facts and data, and uses production rules to determine the objectives and inferences that can be derived from the facts and data.

A blackboard system consists of an area of shared memory (the blackboard) that contains data and multiple independent pattern matching rules. Whenever new data is added to the blackboard, the rules are invoked to determine which patterns match the data. When matches occur, the rule signals a match and can add new data to the blackboard.

Each pot type specifies the number and type of resources contained by instances of such pots. Typically (but not necessarily) there is one resource per pot.

Each individual pot defines whether or not it can be used to fulfil a service event. The decision can be based on any relevant parameter or combination of parameters including (but not limited to):
Interval(s) of time during which the pot is “invalid”, i.e. cannot fulfil any event.
Service type and/or resource type, for example, the pot's resource can only be used in conjunction with SMS messages but not with voice calls, or the pot's resource could be used with all service types. To ensure rapid delivery of the required functionality and to increase performance, the default rule is “cannot fulfil the request”, and this is only explicitly overridden for the relevant small subset of total cases.
Information in the service event such as time of day/week or calendar date, cell, source and/or destination address information such as MSISDNs, amount requested.
Information in the pot such as the resource's magnitude, for example whether the pot would become “overdrawn” if it acceded to a request for resources.
Whether the pot is prepared to partially satisfy an event, or whether it must either satisfy all of an event or take no part in satisfying the event.
Transaction history, for example such as the amount debited during an interval of time or during a session.

If a pot can fulfil a service event, then the rules can take account of any relevant parameter or combination of parameters.

At least some of these parameter values can be included in received service events, and pot traversal may involve matching of these parameter values.

A pot can be a “remote routing pot” which forwards the service event to an external rating and charging entity containing the rating and/or charging rules. To avoid loss of performance, such pots may optionally include a subset of the total rating and charging rules. That subset is required to be sufficient to determine that the external entity will not take any part in fulfilling the service event, and hence there is no need to forward the service event.

A service event can be fulfilled by resources in one or more pots; each service event causing an ordered traversal of pots until the event has been fulfilled or there are no more pots (in which case the event is denied). In either case the service supply entity which originated the service event is informed of the result by sending a service response to the service supply entity.

The pot traversal order:
can be based on any parameter (for example earliest pot expiry date first, or loyalty bonus pots first, or higher priority pots first) or combination of parameters, and
is invariant during the processing of any single service event, but will vary during the lifetime of the pots and accounts.

Once it is determined that a service event can be fulfilled, the relevant pots' resources can either be:
decremented immediately, or
marked as “reserved” (i.e. unavailable) pending a subsequent “capture” or “release” service event.

Regarding interaction with the persistent database 3, when an initial service event for an account is received, the engine core 2 typically retrieves all the account's pots and associated resources from the database 3. If, however, that would be too inefficient, then the engine core can choose to delay retrieving some of the pots/resources until they are required. Such “lazy loading” does not change the behaviour of the rating and charging engine, only its performance. Examples of lazily-loaded pots could be “remote routing pots”, or pots that are not valid at the time of the initial service event. At the end of a sequence of related service events such as a phone call, the engine core 2 stores the changed pots/resources back in the database.

Provisioning operations add pot instances to account instances and add or replace rules, for example in any of the following circumstances:
defined “single-shot” events, e.g. account creation,
regularly repeating events, e.g. once per month a “monthly free minutes pot” is added,
ad-hoc events, e.g. changing tariff plan, or when defined by a network operator's Customer Services Representative,
when a subscriber adds credit to the account, and
in response to pre-programmed triggers related to charging operations, e.g. loyalty scheme bonuses such as spending more than £50 on a single phone call creates a pot containing 5 free SMSs and 5 free ringtones that must be used within one week.

Such addition of pots can be either eager (i.e. before the pot becomes valid), or lazy (i.e. at the first time at which a pot could be used). A typical “eager addition” policy would be to schedule addition when the system is lightly loaded e.g. in the middle of the night. This flexibility considerably simplifies provisioning operations.

Provisioning operations may remove pot instances from an account for example in any/all of these circumstances:
they have expired i.e. it is after the last instant at which they can fulfil a service event,
the value of their resources is zero,
a pre-programmed trigger occurs, for example haven't spent more than £5 in the last week,
ad-hoc events, e.g. changing tariff plan, or when defined by a Network operator Services Representative,
defined “single-shot” events, for example account deletion.

Such removal can occur either eagerly (at the earliest possible time) or lazily (by marking the pot as “removable” and then removing it whenever convenient) without altering the system's operation. A typical “lazy removal” policy would be to schedule removal when the system is lightly loaded, e.g. in the middle of the night. This flexibility considerably simplifies provisioning operations.

Referring again to the flow diagram form in FIGS. 3 to 8, FIG. 3 is a high level flow diagram, FIG. 4 illustrates processing of a service request, FIG. 5 illustrates processing of a service capture, FIG. 6 illustrates processing of a service release, and FIG. 7 illustrates processing of a service debit, FIG. 8 illustrates the internal processing within a remote-routing pot. These diagrams illustrate the advantageous aspect whereby pot traversal is performed and there is a much reduced set of rules to process.

Scenarios outlined below illustrate some examples of operation of the rating and charging engine of the invention.

### Example Scenario 1

### Basic Operation

This illustrates:
lazy and eager provisioning techniques,
multiple local pot types, each with different rating and charging rules and different Resources,
multiple instances of local pot types,
session-based and isolated interactions with the service supply entity, including different service types and parameters,
interaction with the persistent database,
engine core 2 traversing the Pots and invoking the Pots' rules.

Consider a “StandardPrepaid” Pot Type with these rating and charging rules:
voice calls cost £0.10/minute before noon and £0.20/minute after noon,
Ringtones cost £1.00 at all times,
SMSs cost £0.10 at all times,
there are no time restrictions on when the pot is valid (i.e. can be used to fund services).

Consider a subscriber's account that contains a single StandardPrepaid Pot:
potId is 456. In the description below the shorthand pot-456 is used to refer to the pot with id 456,
balance resource is £5.67,
valid all the time.

At a later date, after the rating and charging engine has been implemented and installed, the operator wants to stimulate usage of ringtones, and therefore introduces a new “RingtonePromotion” pot type with these rating and charging rules:
two Ringtones can be downloaded free of charge every Saturday and two every Sunday,
there is no carry-over of unused Ringtones.

The existing “StandardPrepaid” pot type is unchanged, and existing “StandardPrepaid” pot instances are unchanged.

At any convenient time before the promotion starts the provisioning system 4 eagerly adds several instances of the “RingtonePromotion” pot to the account. Typically this would be scheduled to occur when the system load is low (e.g. early hours of a weekday), and the rate at which pots are added can be reduced sufficiently that real-time operation is not adversely affected. The account now contains pots
StandardPrepaid pot-456, as above
RingtonePromotion pot-1005
   balance resource 2 Ringtones
   valid on Saturday 5^{th}
a RingtonePromotion pot-8006
   balance resource 2 Ringtones
   valid on Sunday 6^{th}
a RingtonePromotion pot-9999
   balance resource 2 Ringtones
   valid on Saturday 12^{th}
a RingtonePromotion pot-10000
   balance resource 2 Ringtones
   valid on Sunday 13^{th}.

On Friday 4^{th} at 10 am, a voice call starts, which causes the service supply entity to send a service request to the engine 1. The service type is “VoiceCall”, and the quantity is 60 s. The engine core 2 retrieves the account's pots from the persistent database 4 and using an “earliest expiry date first” pot traversal rule creates this ordered list of pots: [pot-1005, pot-8006, pot-9999, pot-10000, pot-456], and then iterates through the list:
pot-1005 cannot be used for voice calls, and so is skipped over
ditto for pot-8006, pot-9999, pot-10000
pot-456 can be used for voice calls, so the standard prepaid pot type's rating and charging rules are invoked to discover that 60 s costs £0.10. A reservation is made for £0.10 and its available balance resource is now £5.57.

Since the service request has been completely fulfilled, the engine core 2:
iterates through the ordered list of pots, causing them to store any changed resources in the persistent database, and
sends a service response to the service supply entity indicating that the requested 60 s VoiceCall is authorised.

After 30 s the call ends, which causes the service supply entity to send a service capture to the engine 1. The service type is “VoiceCall”, and the quantity is 30 s. The engine core 2 traverses the ordered list and causes the reservation to be removed, pot-456's Pot Type's rating and charging rules to be invoked to discover that the cost was £0.05 and its balance resource to be set to £5.62. The engine core 2
iterates through the ordered list of pots, causing them to store any changed resources in the persistent database, and
sends a service response to the service supply entity indicating that the requested 30 s VoiceCall has been captured.

On Sunday 6^{th}, a Ringtone download is requested so the service supply equipment sends a service debit to the engine 1, with service type “Ringtone” and quantity 1. The engine core 2 creates the same ordered list and iterates through it:
pot-1005 can be used for Ringtones but it is no longer valid, and hence is skipped.
pot-8006 can also be used for Ringtones and is valid, so the RingtonePromotion Pot Type's rating and charging rules are invoked to discover that the cost is 1, and the pot's balance resource is reduced to 1.
pot-9999, pot-10000, pot-456 are skipped since the service debit has been completely satisfied

The engine core 2:
iterates through the ordered list of pots, causing them to store any changed resources in the persistent database
sends a service response to the service supply entity indicating that the requested Ringtone is authorised.

On Sunday 6^{th}, a second Ringtone download is requested so the service supply equipment sends a service debit to the engine 1, with service type “Ringtone” and quantity 1. The only difference is that pot-8006's balance resource is now reduced to 0, and pot-8006 and its balance resource are “eagerly” deleted.

On Sunday 6^{th}, a third Ringtone download is requested so the service supply equipment sends a service debit to the engine 1, with service type “Ringtone” and quantity 1. The engine core creates the ordered list containing the remaining pots [pot-1005, pot-9999, pot-10000, pot-456], and iterates through it:
pot-1005 can be used for Ringtones but it is no longer valid, and hence is skipped,
pot-9999, pot-10000 can be used for Ringtones but are not yet valid, and hence are skipped,
pot-456 can be used for Ringtones and is currently valid, so the StandardPrepaid Pot Type's rating and charging rules are invoked to discover the cost is £1.00, and the pot's balance resource is reduced to £4.62.

The engine core 2
iterates through the ordered list of pots, causing them to store any changed resources in the persistent database,
sends a service response to the service supply entity indicating that the requested Ringtone is authorised.

During a convenient quiet period on the 10^{th}, the provisioning system 4 scans some or all of the accounts and pots and discovers that pot-1005 still exists even though it is no longer valid. The provisioning system then “lazily” deletes the pot and its balance resource.

### Example Scenario 2

### Remote Routing Pot

This illustrates how a remote routing pot interacts with an external rating and charging entity.

Consider a “BusinessPostpaid” pot type that is used to route relevant service events to an external postpaid billing and charging entity. The rating and charging rule is:
if the event's destination MSISDN is prefixed by a predefined shortcode then forward the event and its parameters to the external postpaid entity, and wait for the corresponding response,
if not prefixed, then do nothing.

Consider an account containing:
StandardPrepaid pot-456, as above
BusinessPostpaid pot-23, prefix 9876

An SMS is requested, so the service supply equipment sends a service debit to the engine 1, with service type “SMS”, destination 987601179017896, and quantity 1. The engine core 2 retrieves the account's pots from the database and using a “BusinessPostpaid pots have higher priority” pot traversal rule, creates this ordered list of pots: [pot-23, pot-456], and then iterates through the list:
pot-23 determines that the destination address is prefixed by “9876” so the service debit might be fulfilled by the external rating and charging entity. The service debit event is forwarded to the external rating and charging entity,
the external rating and charging entity responds indicating that the debit is fulfilled.

The service debit has been completely fulfilled, so pot-456 is skipped and the engine core:
iterates through the ordered list of pots, causing them to store any changed resources in the persistent database; in this example no resources have been changed,
sends a service response to the service supply entity indicating that the requested SMS is authorised.

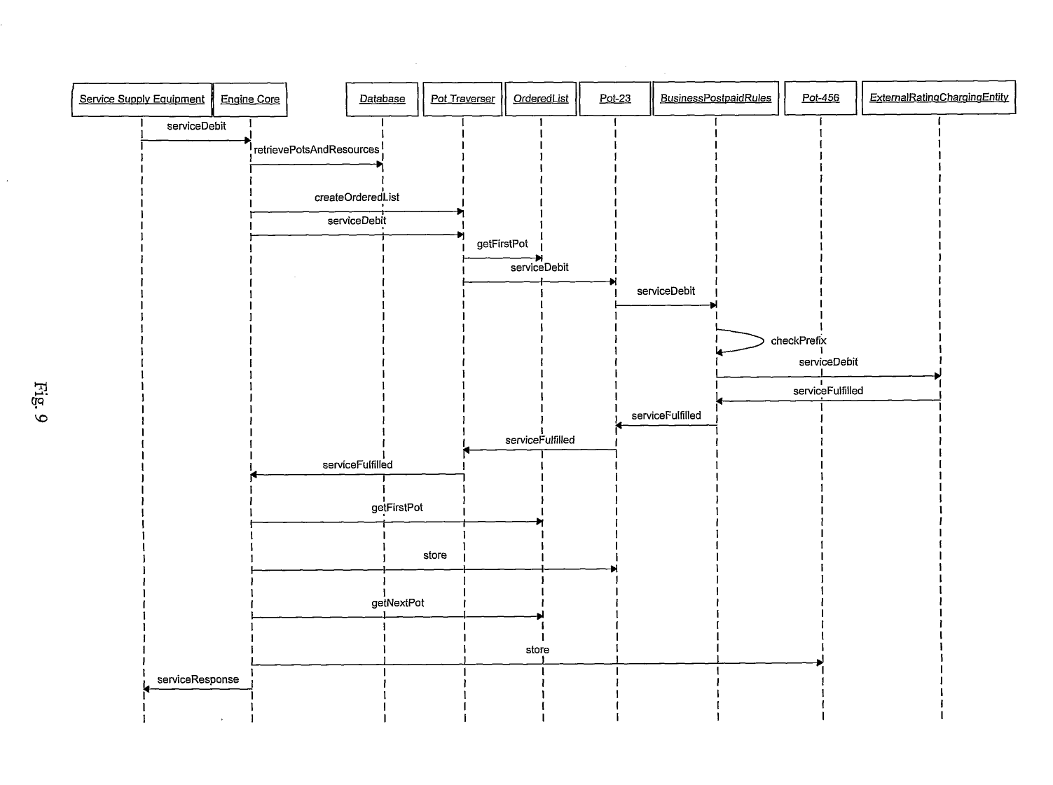

That sequence is illustrated in FIG. 9.

In contrast, if the destination MSISDN had been 01179017896 then the above sequence would have been the same except that:
pot-23 determines that the destination address is not prefixed by “9876”, so the external rating and charging entity will not fulfil the service debit. Pot-23 takes no further part in this sequence; in particular the service debit event is not forwarded, and
the scenario proceeds in a similar way to that described in example scenario 1: pot-456 fulfils service debit and its resource is reduced by £0.10, and the changed resource is stored in the persistent database

The invention is not limited to the embodiments described but may be varied in construction and detail. For example, the invention may be applied to networks other than mobile networks, for example fixed telephony or IP networks. For example, the service may be time of use of a WiFi network or number of bytes downloaded in an IP network. The service events may relate to services other than communication services, for example processing a parking ticket. Also, the invention is applicable to both pre-paid and also post-paid rating and charging systems and services.

1-29. (canceled)

30. A communication network rating and charging engine comprising:
a network interface adapted to receive service events and to send service responses,
a persistent database storing:
a plurality of subscriber accounts, each account containing one or more pots, each pot containing one or more resources consumed during performance of a service by the network, and
rating and charging rules associated with the pots;
an engine core adapted to generate service responses by:
performing in real time a pot traversal operation to determine pots to utilise for a received service event,
the pot traversal operation using a value of at least one parameter, and
performing real time rating and charging by executing the rating and charging rules associated with those pots; and
a provisioning system adapted to provision said rules, accounts, pots, and resources in the persistent database.

31. The rating and charging engine as claimed in claim 30, wherein each pot is an instance of a pot type.

32. The rating and charging engine as claimed in claim 30, wherein each pot is an instance of a pot type, and each pot type is associated with a set of rating and charging rules.

33. The rating and charging engine as claimed in claim 30, wherein each pot is an instance of a pot type, and each pot is associated with a set of one or more resources defined by the pot's associated pot type.

34. The rating and charging engine as claimed in claim 30, wherein each resource is an instance of a resource type.

35. The rating and charging engine as claimed in claim 30, wherein each resource is an instance of a resource type, and the engine core is adapted to recognise service types, and each pot type contains separate rating and charging rules for each <service type, resource type> pair.

36. The rating and charging engine as claimed in claim 30, wherein the engine core is adapted to generate a pot list in a priority order when performing a pot traversal operation, and for attempting to use the pots in the priority order.

37. The rating and charging engine as claimed in claim 30, wherein the engine core is adapted to receive a parameter value in real time.

38. The rating and charging engine as claimed in claim 30, wherein the engine core is adapted to extract a parameter value from a service event.

39. The rating and charging engine as claimed in claim 30, wherein the engine core is adapted to retrieve a parameter value from a pot.

40. The rating and charging engine as claimed in claim 30, wherein a parameter value is an attribute of a resource such as quantity.

41. The rating and charging engine as claimed in claim 30, wherein the engine core is adapted to extract a parameter value from a service event; and the engine core is adapted to extract from a service event a value of a service type parameter.

42. The rating and charging engine as claimed in claim 30, wherein the engine core is adapted to extract a parameter value from a service event; and the engine core is adapted to extract from a service event a value of a parameter representing service quantity.

43. The rating and charging engine as claimed in claim 30, wherein the engine core is adapted to extract a parameter value from a service event; and the engine core is adapted to extract from a service event a value of a parameter representing service event time.

44. The rating and charging engine as claimed in claim 30, wherein the engine core is adapted to extract a parameter value from a service event; and the engine core is adapted to extract from a service event a value of a parameter representing source or destination address.

45. The rating and charging engine as claimed in claim 30, wherein the engine core is adapted to initially use a parameter value to exclude pots that it can determine cannot fulfil the service event, and to pass the service event or a parameter to non-excluded pots, and the pots are adapted to determine autonomously whether they can fulfil the service event and to inform the engine core accordingly.

46. The rating and charging engine as claimed in claim 30, wherein at least some pots include at least one parameter value indicating its suitability for particular service types, and the engine core is adapted to use said parameter values during pot traversal.

47. The rating and charging engine as claimed in any of claim 30, wherein the engine core is adapted to generate a pot list in a priority order when performing a pot traversal operation, and for attempting to use the pots in the priority order; and at least some pots include at least one parameter value for use by the engine core in determining a pot priority order.

48. The rating and charging engine as claimed in claim 30, wherein the rating and charging rules associated with at least two pot types are of different processing techniques.

49. The rating and charging engine as claimed in claim 30, wherein the rating and charging rules associated with at least two pot types are of different processing techniques; and wherein the processing techniques include one or a combination of decision trees, look-up tables, polynomial equations, blackboard systems, forward chaining production systems, and backward chaining inference engines.

50. The rating and charging engine as claimed in claim 30, wherein at least some pots are remote routing pots adapted to automatically and autonomously forward a service event to an external rating and charging entity.

51. The rating and charging engine as claimed in claim 30, wherein at least some pots are remote routing pots adapted to automatically and autonomously forward a service event to an external rating and charging entity; and wherein said pots include rating and charging rules that are sufficient to decide whether or not to forward a service event to an external rating and charging entity.

52. The rating and charging engine as claimed in claim 30, wherein the engine core is adapted to delay retrieval of pots with their resources and associated rules from the database until they are required.

53. The rating and charging engine as claimed in claim 30, wherein the engine core is adapted to delay retrieval of pots with their resources and associated rules from the database until they are required; and wherein the engine core is adapted to, when a service event for an account is received, retrieve from the database to memory all of the account's pots with their resources and associated rules, if this account's pots are not already in memory.

54. The rating and charging engine as claimed in claim 30, wherein the provisioning system is adapted to provision accounts, pots, resources, or rules in real time when they are first required in performance of network services or at any convenient time in advance of it being possible for them to be used in performance of network services.

55. The rating and charging engine as claimed in claim 30, wherein the provisioning system is adapted to send a notification to the engine core when a change to the persistent database has been made.

56. The rating and charging engine as claimed in claim 30, wherein the provisioning system is adapted to delete pots in real time when it is first apparent that they can no longer be used in performance of network services or at any convenient time after they can no longer be used in performance of network services.

57. The rating and charging engine as claimed in claim 30, wherein the engine core is adapted to retrieve all of the rules to memory at initialization or whenever the rules are re-provisioned.

58. A computer readable medium comprising software code for performing the following steps when executing on a digital processor of communication network rating and charging engine:
a network interface receiving service events and to send service responses,
a persistent database storing:
a plurality of subscriber accounts, each account containing one or more pots, each pot containing one or more resources consumed during performance of a service by the network, and
rating and charging rules associated with the pots;
an engine core generating service responses by:
performing in real time a pot traversal operation to determine pots to utilise for a received service event,
the pot traversal operation using a value of at least one parameter, and
performing real time rating and charging by executing the rating and charging rules associated with those pots; and
a provisioning system provisioning said rules, accounts, pots, and resources in the persistent database.
